(19) United States
(12) Patent Application Publication
(10) Pub. No.: US 2021/0107525 A1
(43) Pub. Date: Apr. 15, 2021

(54) AUTOMATIC OPERATING APPARATUS

(71) Applicant: TOYOTA JIDOSHA KABUSHIKI KAISHA, Toyota-shi (JP)

(72) Inventor: Eiji NUNOBIKI, Numazu-shi (JP)

(73) Assignee: TOYOTA JIDOSHA KABUSHIKI KAISHA, Toyota-shi (JP)

(21) Appl. No.: 17/023,743

(22) Filed: Sep. 17, 2020

(30) Foreign Application Priority Data
Oct. 10, 2019 (JP) 2019-186859

(51) Int. Cl. B60W 60/00

(52) U.S. Cl. CPC B60W 60/0051; B60W 60/0059; B60W 2552/53

(57) ABSTRACT

An automatic operating apparatus is configured to perform an automatic operation control of automatically operating a host vehicle when an automatic operation startable condition is satisfied. The automatic operating apparatus is provided with: a receiver that receives an execution reservation of the automatic operation control before the automatic operation startable condition is satisfied; and a controller that automatically performs the automatic operation control when the automatic operation startable condition is satisfied and when a travel state condition associated with a travel state of the host vehicle is satisfied, after the execution reservation is received by the receiver.

### CROSS-REFERENCE TO RELATED APPLICATIONS

This application is based upon and claims the benefit of priority of the prior Japanese Patent Application No. 2019-186859, filed on Oct. 10, 2019, the entire contents of which are incorporated herein by reference.

### BACKGROUND

### 1. Technical Field

Embodiments of the present disclosure relate to an automatic operating apparatus.

### 2. Description of the Related Art

For this type of apparatus, for example, there is proposed an apparatus configured to perform an operation control, which is included in a travel plan generated by an automatic operation function, when the operation control is approved by a driver in advance (refer to Japanese Patent Application Laid Open No. 2017-167737 (Patent Literature 1)).

In a technology/technique described in the Patent Literature 1, the operation control that is once approved is likely performed regardless of a travel state of a host vehicle after the approval, which is technically problematic.

### SUMMARY

In view of the problem described above, it is therefore an object of embodiments of the present disclosure to provide an automatic operating apparatus that can safely perform a control that is approved (in other words, reserved) in advance.

The above object of embodiments of the present disclosure can be achieved by an automatic operating apparatus is configured to perform an automatic operation control of automatically operating a host vehicle when an automatic operation startable condition is satisfied, the automatic operating apparatus provided with: a receiver that receives an execution reservation of the automatic operation control before the automatic operation startable condition is satisfied; and a controller that automatically performs the automatic operation control when the automatic operation startable condition is satisfied and when a travel state condition associated with a travel state of the host vehicle is satisfied, after the execution reservation is received by the receiver.

On the automatic operating apparatus, when the execution reservation is received by the receiver, the automatic operation control is performed only when the automatic operation startable condition and the travel state condition are satisfied. In other words, the automatic operating apparatus may perform the automatic operation control in view of the travel state of the host vehicle after the execution reservation is received. Therefore, according to the automatic operating apparatus, it is possible to safely perform the automatic operation control for which the execution reservation is made.

### BRIEF DESCRIPTION OF THE DRAWINGS

FIG. 1 is a block diagram illustrating a configuration of an automatic operating apparatus according to an embodiment; and

FIG. 2 is a flowchart illustrating operations of the automatic operating apparatus according to the embodiment.

### DETAILED DESCRIPTION OF THE EMBODIMENT

An automatic operating apparatus according to an embodiment of the present disclosure will be explained. The automatic operating apparatus is configured to perform an automatic operation control of automatically operating a host vehicle when an automatic operation startable condition is satisfied. Here, a detailed explanation of the “automatic operation control” will be omitted because various existing aspects can be applied to the automatic operation control.

The “automatic operation startable condition” may be a condition for determining whether or not the automatic operation control can be performed, and may be typically a condition determined in advance, but may be a condition that varies depending on some physical quantity or parameter. An example of the automatic operation startable condition may be that the host vehicle is traveling on a road or in an area suitable for the automatic operation, that the position and azimuth (or direction) of a vehicle 1 is estimated by “self-position estimation (or localization)”, i.e., that a high-precision vehicle position is estimated, that various sensors for detecting the behavior of the host vehicle are normal, that information indicating a situation around the host vehicle is sufficiently obtained, or the like. The “road or area suitable for the automatic operation” may include, for example, a road, an expressway, or the like that allows the use of a high-precision map. A detailed explanation of the localization will be omitted because various existing aspects can be applied to the localization.

The automatic operating apparatus is provided with a receiver and a controller. The receiver is configured to receive an execution reservation of the automatic operation control. The receiver may be, for example, a human machine interface (HMI), such as a switch and a touch panel. On the automatic operating apparatus, the automatic operation control is not performed unless an execution instruction or an execution approval of the automatic operation control is received by the receiver from a driver. The execution instruction or the execution approval of the automatic operation control that is received by the receiver before the automatic operation startable condition is satisfied, is referred to as the “execution reservation” herein.

The controller is configured to automatically perform the automatic operation control. Here, in particular, the controller may automatically perform the automatic operation control when the automatic operation startable condition is satisfied and when a travel state condition associated with a travel state of the host vehicle is satisfied, after the execution reservation is received by the receiver.

The “travel state condition” may be one of conditions for determining whether or not the automatic operation control can be performed after the execution reservation is received by the receiver. As in the “automatic operation startable condition” described above, the “travel state condition” may be typically a condition determined in advance, but may be a condition that varies depending on some physical quantity or parameter.

An example of the travel state condition may be that the behavior of the host vehicle is stable, that the host vehicle is traveling in a central part of a traffic lane (or the host vehicle is away from a traffic lane end by a predetermined distance or more), or the like. In other words, it can be said that the travel state condition is a condition for determining whether or not the host vehicle is traveling in a state in which the automatic operation control can be safely performed. The expression that the “behavior of the host vehicle is stable” may include, for example, that a speed change is relatively small, that the magnitude of acceleration and deceleration is relatively small, that a yaw moment change is relatively small, that the magnitude of a yaw rate is relatively small, that a steering amount change is relatively small, that the magnitude of steering angular velocity is relatively small, and the like.

On the automatic operating apparatus, when the execution reservation is received by the receiver, the automatic operation control is performed only when the automatic operation startable condition and the travel state condition are satisfied. In other words, on the automatic operating apparatus, when the execution reservation is received by the receiver, even if the automatic operation startable condition is satisfied, the automatic operation control is not performed unless the host vehicle is running in the state in which the automatic operation control can be safely performed (i.e., unless the travel state condition is satisfied). Therefore, according to the automatic operating apparatus, it is possible to safely perform the automatic operation control for which the execution reservation is made.

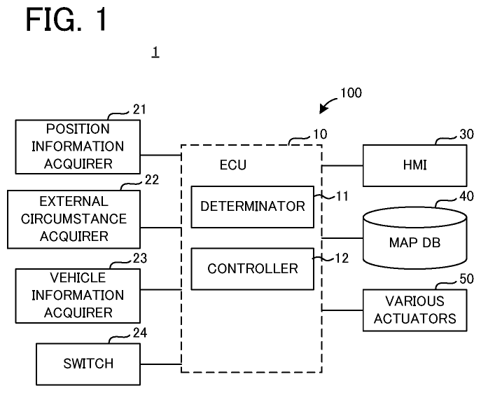

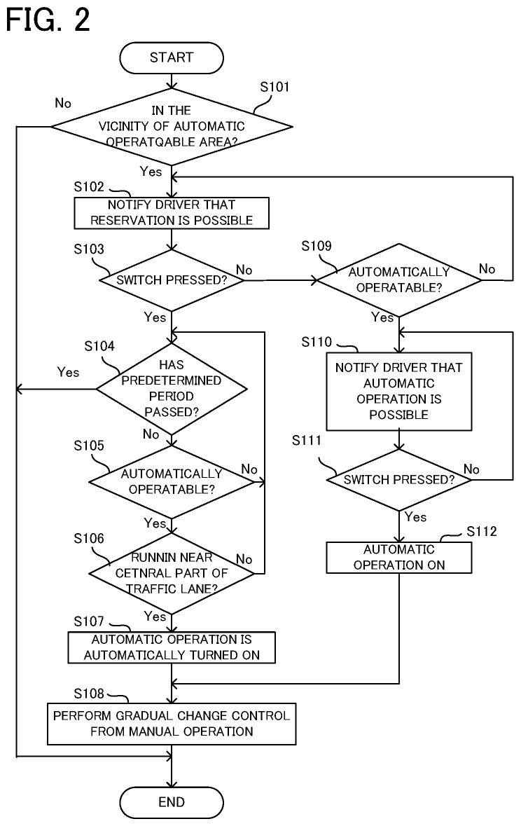

An automatic operating apparatus 100, which is a specific example of the automatic operating apparatus according to the embodiment, will be explained with reference to FIG. 1 and FIG. 2.

The automatic operating apparatus 100 is mounted on a vehicle 1 corresponding to the “host vehicle” described above. The automatic operating apparatus 100 is provided with an electronic control unit (ECU) 10, a position information acquirer 21, an external circumstance acquirer 22, a vehicle information acquirer 23, a switch 24, a HMI 30, and a map database 40 (hereinafter written as “map DB 40” as occasion demands). The HMI 30 and the map DB 40 may be not provided only for the automatic operating apparatus 100, but may be shared with another apparatus (e.g., a navigation apparatus, etc.).

The position information acquirer 21 is configured to obtain position information associated with the vehicle 1, for example, on the basis of an output of a global positioning system (GPS), or the like. The external circumstance acquirer 22 is configured to obtain a situation around the vehicle 1 (e.g., information associated with an obstacle, information associated with a traffic light, information associated with a road sign and road marking, etc.), for example, on the basis of an in-vehicle camera, a radar, a light detection and ranging (LiDAR), or the like. The vehicle information acquirer 23 is configured to obtain vehicle information indicating a state of the vehicle 1, for example, on the basis of a speed sensor, an acceleration sensor, or the like. A detailed explanation of a method of obtaining each of the position information, an external situation, and a vehicle situation will be omitted because various existing aspects can be applied to the method.

The switch 24 corresponds to an example of the “receiver” described above. The switch 24 may be a switch whose position (e.g., an ON position, an OFF position, etc.) is physically changed by an operation performed by a driver, or may be a virtual switch realized, for example, by a touch panel or the like. The switch 24 is configured to receive an execution instruction or an execution approval of the automatic operation control by the driver of the vehicle 1. After the execution instruction or the execution approval of the automatic operation control is received by the driver who operates the switch 24, the execution instruction or the execution approval received may be also canceled by the driver operating the switch 24 again.

The ECU 10 may include a determinator 11 and a controller 12, as processing blocks logically realized therein or as processing circuits physically realized therein. The determinator 11 is configured to determine whether or not each of the “automatic operation startable condition” and the travel state condition described above is satisfied. The controller 12 is configured to perform the automatic operation control. The controller 12 is configured to automatically operate the vehicle 1 by controlling various actuators 50 (e.g., a throttle actuator, a brake actuator, a steering actuator, etc.) while performing the automatic operation control. The controller 12 corresponds to an example of the “controller” described above.

Next, operations of the automatic operating apparatus 100 (which is particularly the determinator 11 and the controller 12) will be specifically explained with reference to a flowchart in FIG. 2. At a time point at which the operations illustrated in FIG. 2 are started, the vehicle 1 is operated by the driver.

In FIG. 2, the determinator 11 determines whether or not the vehicle 1 is traveling in the vicinity of an automatic operatable area, on the basis of the position information obtained by the position information acquirer 21 and the map information stored in the map DB 40 (step S101). The “automatic operatable area” may be, for example, a road, an expressway, or the like that allows the use of a high-precision map. The “vicinity of the automatic operatable area” may vary depending on a speed of the vehicle 1, but may be, for example, a range in which the vehicle 1 can reach the automatic operatable area in several to several ten seconds”.

In the step S101, if it is determined that the vehicle 1 is not traveling in the vicinity of the automatic operatable area (the step S101: No), the operations illustrated in FIG. 2 are ended temporarily. Then, after a lapse of a predetermined period (e.g., second ten milliseconds to several hundred milliseconds), the step S101 is performed again. In other words, the operations illustrated in FIG. 2 are repeatedly performed with a period corresponding to the predetermined period.

In the step S101, if it is determined that the vehicle 1 is traveling in the vicinity of the automatic operatable area (the step S101: Yes), the controller 12 notifies the driver that the execution reservation of the automatic operation control is possible, via the HMI 30 (step S102).

Then, the determinator 11 determines whether or not the switch 24 is pressed by the driver (step S103). In the step S103, if it is determined that the switch 24 is pressed, i.e., if the execution reservation of the automatic operation control is received (the step S103: Yes), the determinator 11 determines whether or not a predetermined period (e.g., 10 seconds, etc.) has passed since the switch 24 is pressed (step S104).

In the step S103, if it is determined that the switch 24 is not pressed, i.e., if the execution reservation of the automatic operation control is not received (the step S103: No), the determinator determines whether or not it is automatically operatable (step S109). Specifically, as in an step S105 described below, each of the followings may be determined; namely, (i) whether or not the vehicle 1 is positioned within the automatic operatable area, (ii) whether or not the localization is completed, (iii) whether or not the situation around the vehicle 1 is obtained by the external situation acquirer 22, and (iv) whether or not the vehicle information is obtained by the vehicle information acquirer 23.

In the step S109, if it is determined that it is not automatically operatable (the step S109: No), the step S102 is performed. It is because in this case the vehicle 1 is still traveling in the vicinity of the automatic operatable area.

In the step S104, if it is determined that the predetermined period has passed since the switch 24 is pressed (step S104: Yes), the operations illustrated in FIG. 2 are ended temporarily. Then, after a lapse of the predetermined period, the step S101 is performed again. This is performed in relation to steps S105 and S106. In other words, if the automatic operation is not possible (e.g., if an automatic operation startable condition is not satisfied) even if the predetermined period has passed since the switch 24 is pressed, the operations illustrated in FIG. 2 are ended temporarily, for example, from a safety viewpoint (as a result of which the execution reservation is automatically canceled).

In the step S104, if it is determined that the predetermined period has not passed since the switch 24 is pressed (step S104: No), the determinator 11 determines whether or not it is automatically operatable (step S105). Specifically, the determinator may determine each of the followings; namely, (i) whether or not the vehicle 1 is positioned within the automatic operatable area, (ii) whether or not the high-precision vehicle position of the vehicle 1 is estimated by the self-position estimation (hereinafter referred to as that “the localization is completed” as occasion demands), (iii) whether or not the situation around the vehicle 1 is obtained by the external situation acquirer 22, and (iv) whether or not the vehicle information is obtained by the vehicle information acquirer 23.

Here, whether or not the localization is completed may be determined, for example, in the following manner. In other words, if the high-precision vehicle position of the vehicle 1 is estimated by the self-position estimation, then, an error is caused, for example, by the position information obtained by the position information acquirer 21, the map information stored in the map DB 40, or the like (and this error will be hereinafter referred to as a “localization error” as occasion demands). The determinator 11 may determine that the localization is completed if the localization error is less than or equal to a threshold value, and may determine that the localization is not completed if the localization error is greater than the threshold value.

The determinator 11 may determine that it is automatically operatable (i) when the vehicle 1 is positioned within the automatic operatable area, (ii) when the localization is completed, (iii) when the situation around the vehicle 1 is obtained by the external situation acquirer 22, and (iv) when the vehicle information is obtained by the vehicle information acquirer 23. The conditions that “the vehicle 1 is positioned within the automatic operatable area”, that “the localization is completed”, that “the situation around the vehicle 1 is obtained by the external situation acquirer 22”, and that “the vehicle information is obtained by the vehicle information acquirer 23”, correspond to an example of the “automatic operation startable condition” described above.

In parallel with, or before or after the step S105, the determinator 11 determines whether or not the vehicle is traveling near a central part of a traffic lane (step S106). The “central part of the traffic lane” is not limited to the center of the traffic lane, but may conceptually include a position distant from the center of the traffic lane to a greater or lesser extent in a width direction of the traffic lane. The expression that “the vehicle 1 is traveling near the central part of the traffic lane” may not only mean that the vehicle 1 is traveling in a state in which an entire body of the vehicle 1 is included in a range of the central part of the traffic lane, but may also mean, for example, that the vehicle 1 is traveling in a state in which a part of the vehicle 1 is out of the range of the central part of the traffic lane while the center of the vehicle 1 is included in the range of the central part of the traffic lane. A detailed explanation of “determining whether or not the vehicle 1 is traveling near the central part of the traffic lane” will be omitted because various existing aspect can be applied to the determination. The condition that “the vehicle 1 is traveling near the central part of the traffic lane” corresponds to an example of the “travel state condition” described above.

If it is determined in the step S105 that it is not automatically operatable (the step S105: No), or if it is determined in the step S106 that the vehicle 1 is not traveling near the central part of the traffic lane (the step S106: No), the step S104 is performed.

If it is determined in the step S105 that it is automatically operatable (the step S105: Yes), or if it is determined in the step S106 that the vehicle 1 is traveling near the central part of the traffic lane (the step S106: Yes), the controller 12 automatically starts to perform the automatic operation control (step S107). In other words, in the step S107, the automatic operation control for which the execution reservation is made is started.

The controller 12 performs a gradual change control such that the behavior of the vehicle 1 does not suddenly change when the operation is transferred from the operation by the driver (i.e., manual operation) to the automatic operation by the automatic operation control (step S108). A detailed explanation of the gradual change control will be omitted because various existing aspects can be applied to the gradual change control. After the end of the gradual change control, the vehicle 1 travels due to the automatic operation by the automatic operation control.

In the step S103 described above, if it is determined that the switch 24 is not pressed, i.e., if the execution reservation of the automatic operation control is not received (the step S103: No), the determinator 11 determines whether or not it is automatically operatable (the step S109). Specifically, as in the step S105 described above, the determinator 11 may determine each of the followings; namely, (i) whether or not the vehicle 1 is positioned within the automatic operatable area, (ii) whether or not the localization is completed, (iii) whether or not the situation around the vehicle 1 is obtained by the external situation acquirer 22, and (iv) whether or not the vehicle information is obtained by the vehicle information acquirer 23.

In the step S109, if it is determined that it is not automatically operatable (the step S109: No), the step S102 is performed. It is because in this case the vehicle 1 is still traveling in the vicinity of the automatic operatable area.

On the other hand, in the step S109, if it is determined that it is automatically operatable (the step S109: Yes), the controller 12 notifies the driver that the execution of the automatic operation control is possible, via the HMI 30 (step S110). In this case, after the step S101 described above and before the start of the step S109, the vehicle 1 moves into the automatic operatable area from the vicinity of the automatic operatable area.

The determinator 11 then determines whether or not the switch 24 is pressed by the driver (step S111). In the step S111, if it is determined that the switch 24 is not pressed, i.e., if the execution instruction of the automatic operation control is not received (the step S111: No), the step S110 is performed. The switch pressed at this time may be a switch that is different from the switch 24. In other words, the switch 24 for receiving the execution reservation of the automatic operation control and a switch for receiving the execution instruction of the automatic operation control may be provided.

In the step S111, if it is determined that the switch 24 is pressed, i.e., if the execution instruction of the automatic operation control is received (the step S111: Yes), the controller 12 starts to perform the automatic operation control (step S112). Then, the S108 is performed.

A first threshold value associated with the localization error, which is used to determine whether or not the localization is completed in the step S105, is less than a second threshold value associated with the localization error, which is used to determine whether or not the localization is completed in the step S113.

Here, when the execution reservation is made (i.e., when the step S105 is performed), there is a certain degree of period between when the driver of the vehicle 1 makes the execution reservation and when the automatic operation control is actually started. On the other hand, when the execution instruction is given (i.e., when the step S113 is performed), the automatic operation control is started in a relatively short period after the driver of the vehicle 1 gives the execution instruction. Thus, when the execution reservation is made, for example, there is a high possibility that the situation around the vehicle 1 (e.g., another vehicle that runs around the vehicle 1, etc.) or the like changes before the automatic operation control is actually started, in comparison with that when the execution instruction is given. In other words, when the execution reservation is made, for example, there is a high possibility that there is a deviation between the situation at a time point at which the driver determines to perform the automatic operation and the situation at a time point at which the automatic operation control is actually started. Thus, in order to sufficiently secure the safety of the vehicle 1, the first threshold value is set to be less than the second threshold value.

(Technical Effect)

On the automatic operating apparatus 10, when the execution reservation is received by the switch 24 (i.e., if it is determined in the step S103 that the switch is pressed), the automatic operation control is performed only if it is determined in the step S105 that it is automatically operatable and if it is determined in the step S106 that the vehicle 1 is traveling near the central part of the traffic lane. In other words, on the automatic operating apparatus 10, the automatic operation control is performed only if both the automatic operation startable condition and the travel state condition are satisfied. Therefore, according to the automatic operating apparatus 10, it is possible to safely perform the automatic operation control, in comparison with an apparatus according to a comparative example in which the automatic operation control is performed on condition that only the automatic operation startable condition is satisfied, after the execution reservation is received.

On the automatic operating apparatus 10, as described above, the first threshold value associated with the localization error when the execution reservation of the automatic operation control is received by the switch 24, is set to be less than the second threshold value associated with the localization error when the execution instruction of the automatic operation control is received by the switch 24. Thus, according to the automatic operating apparatus 10, it is possible to more safely start the automatic operation control when the automatic operation control is performed in accordance with the execution reservation.

The steps S101 to S107 and the steps S109 to S114 may be constructed as different processing routines.

Various aspects of embodiments of the present disclosure derived from the embodiment explained above will be explained hereinafter.

An automatic operating apparatus according to an aspect of embodiments of the present disclosure is an automatic operating apparatus configured to perform an automatic operation control of automatically operating a host vehicle when an automatic operation startable condition is satisfied, the automatic operating apparatus provided with: a receiver that receives an execution reservation of the automatic operation control before the automatic operation startable condition is satisfied; and a controller that automatically performs the automatic operation control when the automatic operation startable condition is satisfied and when a travel state condition associated with a travel state of the host vehicle is satisfied, after the execution reservation is received by the receiver.

In an aspect of the automatic operating apparatus, the receiver is receives an execution instruction of the automatic operation control after the automatic operation startable condition is satisfied, the automatic operation startable condition includes that localization is completed for the host vehicle, and when the execution reservation is received by the receiver, a threshold value associated with a localization error in determining whether or not the localization is completed for the host vehicle is smaller than that when the execution instruction is received by the receiver without receiving the execution reservation.

In another aspect of the automatic operating apparatus, the travel state condition includes that the host vehicle is traveling near a central part of a traffic lane, and that behavior of the host vehicle is stable.

The present disclosure may be embodied in other specific forms without departing from the spirit or characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. An automatic operating apparatus configured to perform an automatic operation control of automatically operating a host vehicle when an automatic operation startable condition is satisfied, the automatic operating apparatus comprising:
a receiver that receives an execution reservation of the automatic operation control before the automatic operation startable condition is satisfied; and
a controller that automatically performs the automatic operation control when the automatic operation startable condition is satisfied and when a travel state condition associated with a travel state of the host vehicle is satisfied, after the execution reservation is received by said receiver.

2. The automatic operating apparatus according to claim 1, wherein
said receiver receives an execution instruction of the automatic operation control after the automatic operation startable condition is satisfied,
the automatic operation startable condition includes that localization is completed for the host vehicle, and
when the execution reservation is received by said receiver, a threshold value associated with a localization error in determining whether or not the localization is completed for the host vehicle is smaller than when the execution instruction is received by said receiver without receiving the execution reservation.

3. The automatic operating apparatus according to claim 1, wherein the travel state condition includes that the host vehicle is traveling near a central part of a traffic lane, and that behavior of the host vehicle is stable.

4. The automatic operating apparatus according to claim 2, wherein the travel state condition includes that the host vehicle is traveling near a central part of a traffic lane, and that behavior of the host vehicle is stable.
